(19) United States
(12) Patent Application Publication
(10) Pub. No.: US 2007/0036149 A1
(43) Pub. Date: Feb. 15, 2007

(54) TELEPHONE CONVERSATION ISOLATION AND ENHANCEMENT SYSTEMS

(76) Inventor: Mark Snedecor, Granite Bay, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/419,682

(22) Filed: May 22, 2006

Related U.S. Application Data
(60) Provisional application No. 60/684,606, filed on May 24, 2005.

(51) Int. Cl. H04M 11/00; H04L 12/66

(52) U.S. Cl. 370/352; 379/52

(57) ABSTRACT

Telephone conversation isolation and enhancement systems for a caller using a telephone for a telephone call. The systems include a housing comprising an edge that circumferentially bounds an opening. The edge may contact a caller's head to create a substantially circumferentially continuous interface between the edge and the caller's head. The interface may enclose the caller's mouth such that speech sounds produced by the caller may emanate into the housing. The housing may attenuate transmission of the speech sounds to a call neighbor. The systems may include a first communication path configured to enable speech sounds produced by the caller to reach a telephone and a second communication path configured to enable transmission of audio signals from the telephone to at least one of the caller's ears. The second communication path may attenuate transmission of audio signals from the telephone to the call neighbor.

### RELATED APPLICATION

This application claims priority to U.S. Provisional Patent Application Ser. No. 60/684,606, which was filed on May 24, 2005 and is entitled “Telephone Conversation Isolation and Enhancement System.” The complete disclosure of the above-identified patent application is hereby incorporated by reference for all purposes.

### FIELD OF THE DISCLOSURE

The present disclosure relates to accessories for telephones, and more particularly to systems configurable to isolate the audio impact of and/or to enhance the quality of telephone calls.

### BACKGROUND OF THE DISCLOSURE

The expanding use of telephones, particularly mobile or cellular telephones, coupled with increasing population densities in modern society has created a need to alleviate the adverse effects on privacy arising from such increased telephone usage.

For example, the high population densities found in the “cubical culture” of many modern offices tend to lack sufficient privacy to make telephone calls. People working in such an environment must face two diminutions of their privacy. Not only must people making telephone calls in such an environment be concerned that their neighbors may listen to their telephone calls, those same people may also be involuntarily submitted to the distraction of their neighbors' telephone calls. Further, the quality of telephone calls made in such an environment may be diminished due to high levels of background noise that may be transmitted along with a caller's voice and may prevent a call receiver from clearly hearing the caller's voice during the telephone call. Further, the expanding use of telephones, particularly mobile or cellular telephones, in crowded public spaces, such as public transportation and the potential use of cellular telephones on commercial airliners, raises similar privacy concerns for all involved.

Just as few people want their neighbors listening to their telephone calls, most people would prefer to avoid the distraction of being subjected to their neighbors' telephone calls. Ideally, a caller in such environments could shield the sound of their own call from their neighbors, which would enhance both the caller's and the neighbors' privacy, as well as shield their own call from outside noise, which would enhance the quality of their own call.

### SUMMARY OF THE DISCLOSURE

Telephone conversation isolation and enhancement systems suitable for use by a caller who is using a telephone to participate in a telephone call. The systems may include an elongate housing comprising an edge that circumferentially bounds an opening. The edge may contact the caller's head to create a substantially circumferentially continuous interface between the edge and the caller's head when the housing is disposed with the opening proximate the caller's head. The interface may enclose the caller's mouth such that speech sounds produced by the caller may emanate into a volume, or space, enclosed by the housing and a portion of the caller's head that is bounded by the interface. The housing may attenuate transmission of the speech sounds to a call neighbor. The systems may include a first communication path configured to enable speech sounds produced by the caller to reach a telephone and a second communication path configured to enable transmission of audio signals from the telephone to at least one of the caller's ears. The second communication path may attenuate transmission of audio signals from the telephone to the call neighbor.

A method permitting a caller using a telephone to participate in a telephone call to isolate sounds associated with the telephone call from call neighbors may include providing an elongate housing comprising an edge that circumferentially bounds an opening on the housing. The method may include disposing the housing proximate the caller's head such that the edge contacts the caller's head and creates a substantially circumferentially continuous interface between the edge and the caller's head. The interface may enclose the caller's mouth such that speech sounds produced by the caller may emanate into a volume enclosed by the housing and a portion of the caller's head that is bounded by the interface. The housing may attenuate transmission of the speech sounds to a call neighbor. The method may include speaking into the volume such that speech sounds produced by the caller are transmitted to a telephone as well as receiving audio signals produced by the telephone proximate at least one of the caller's ears.

A method for a caller using a telephone to participate in a telephone call that may enable the caller to isolate sounds associated with the telephone call from call neighbors may include providing an elongate housing configured to enclose a volume that contains the caller's mouth when the housing is disposed proximate the caller's head such that speech sounds produced by the caller will emanate into the volume. The housing may attenuate transmission of the speech sounds to a call neighbor. The method may include providing a first communication path that enables transmission of speech sounds produced by the caller to the telephone and providing a second communication path that enables transmission of audio signals produced by the telephone to at least one of the caller's ears. The second communication path may attenuate transmission of audio signals from the telephone to a call neighbor.

### BRIEF DESCRIPTION OF DRAWINGS

FIG. 1 is a block diagram of a telephone conversation isolation and enhancement system according to the present disclosure.

FIG. 2 is a block diagram of another embodiment of the telephone conversation isolation and enhancement system of FIG. 1.

FIG. 3 is a fragmentary, partial cross-sectional view schematically showing an embodiment of a seal that may be formed by a telephone conversation isolation and enhancement system according to the present disclosure.

FIG. 4 is a fragmentary perspective view of an embodiment of the telephone conversation isolation and enhancement system of FIG. 2 shown in use.

FIG. 5 is a cross-sectional view of the telephone conversation isolation and enhancement system of FIG. 4 showing an installation of a telephone.

FIG. 6 is a cross-sectional view of another embodiment of the telephone conversation isolation and enhancement system of FIG. 2 showing an installation of a telephone.

FIG. 7 is a perspective view of another embodiment of the telephone conversation isolation and enhancement system of FIG. 2 shown in use.

FIG. 8 is a front view of the telephone conversation isolation and enhancement system of FIG. 7 showing installation of a telephone.

FIG. 9 is a cross-sectional view of the telephone conversation isolation and enhancement system of FIG. 7 showing an installation of a telephone.

FIG. 10 is a block diagram of another embodiment of the telephone conversation isolation and enhancement system according to the present disclosure.

FIG. 11 is a fragmentary perspective view of an embodiment of the telephone conversation isolation and enhancement system of FIG. 10 shown in use.

FIG. 12 is a cross-sectional view of the telephone conversation isolation and enhancement system of FIG. 11 showing an installation of a telephone.

FIG. 13 is a block diagram of another embodiment of the telephone conversation isolation and enhancement system of according to the present disclosure.

FIG. 14 is a cross-sectional view of an embodiment of the telephone conversation isolation and enhancement system of FIG. 13 showing an installation of a telephone.

FIG. 15 is a block diagram of another embodiment of the telephone conversation isolation and enhancement system according to the present disclosure.

FIG. 16 is a block diagram of another embodiment of the telephone conversation isolation and enhancement system according to the present disclosure.

### DETAILED DESCRIPTION AND BEST MODE OF THE DISCLOSURE

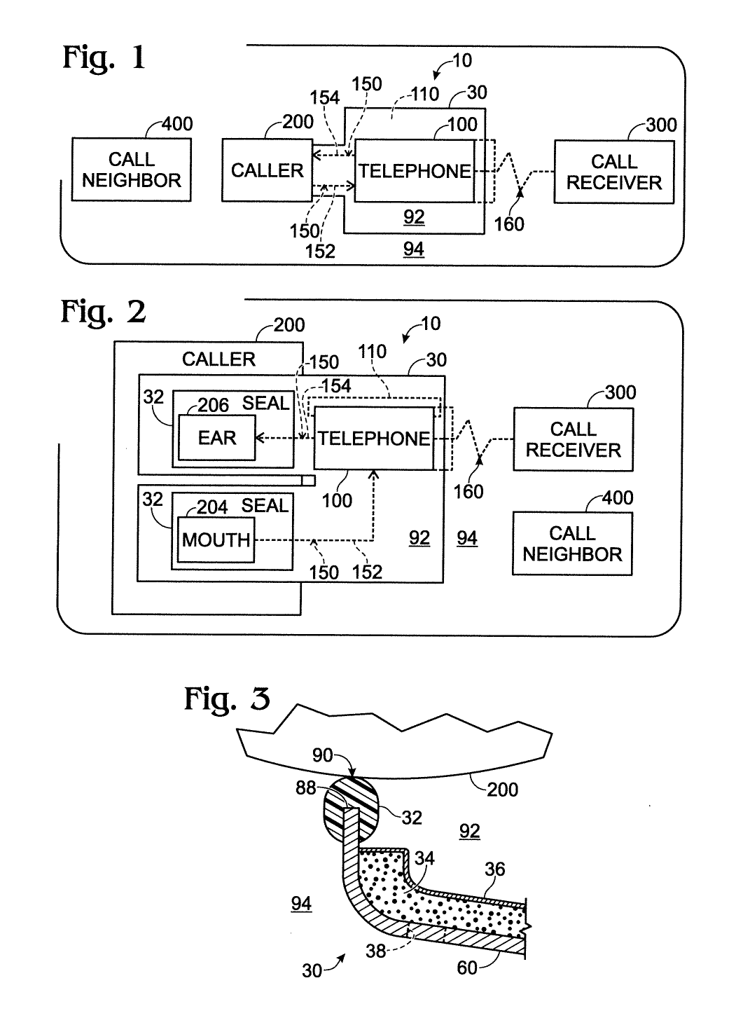

An illustrative example of a telephone conversation isolation and enhancement system according to the present disclosure is shown schematically in FIG. 1 and indicated generally at 10. To illustrate applications of system 10, various exemplary embodiments of the telephone conversation isolation and enhancement system 10 will be described herein with reference to the interaction of three participating parties: caller 200, call receiver 300, and call neighbor 400. Caller 200 refers to the person using a telephone 100 to make telephone calls. Caller 200 may make outgoing telephone calls, such as to call receiver 300. Additionally, caller 200 may receive incoming telephone calls, such as made by a person who may not be present in the immediate area adjacent caller 200, such as call receiver 300. Call receiver 300 may be outside the proximity of caller 200 and may receive incoming telephone calls, such as from caller 200 and/or may initiate telephone calls to caller 200. Call neighbor 400 refers to a person or entity located in the general proximity of caller 200 at such proximity that call neighbor 400 may be able to hear, through some method at least partially involving the propagation of sound waves starting generally in proximity to caller 200, at least part of telephone calls made by or to caller 200. Call neighbor 400 need not be in the immediate proximity of caller 200 and may be some distance away.

The telephone conversation isolation and enhancement system 10 may be configured for use by caller 200 when using a telephone 100 to make or receive telephone calls 160 to or from call receiver 300. The telephone conversation isolation and enhancement system 10 may include a housing 30, which may include, or be configured to receive, a telephone 100. Various embodiments of housing 30 may be configured to receive a variety of telephones such as cellular telephones, cordless telephones, wireless telephones, wired phones such as a standard telephone handset, and the like. Housing 30 (or another suitable portion of system 10) may be configured to receive a predetermined size or configuration of telephone. Some embodiments of housing 30 may be configured to universally receive a variety of sizes and/or types of telephones. For example, housing 30 (or another suitable portion of system 10) may include at least one mount 110 (schematically represented in FIG. 1) that is adapted to be releasably coupled to a telephone, such as a mobile phone, to at least temporarily secure the telephone 100 in an operative position for use with system 10.

When telephone 100 is secured in an operative position for use with system 10, at least one communication path 150 may be established between caller 200 and telephone 100. The at least one communication path 150 may permit the transmission of audio signals or sounds 152 from caller 200 to telephone 100. For example, as illustrated in FIG. 2, at least one of the at least one communication paths 150 may carry audio signals or sounds 152, such as voice sounds, from the mouth of caller 200 to telephone 100. The at least one communication path 150 may permit the transmission of audio signals or sounds 154 from telephone 100 to caller 200. For example, as illustrated in FIG. 2, at least one of the at least one communication paths 150 may carry audio signals or sounds 154, such as corresponding to signals received from call receiver 300, from telephone 100 to at least one of the ears of caller 200. In some exemplary embodiments, the at least one communication path 150 may be configured to transmit audio signals or sounds via any suitable combination of the propagation of sound and/or any suitable combination of electronic, electromagnetic, and/or radio transmission.

As indicated in dashed lines in FIG. 1, it is within the scope of the present disclosure that at least a portion of telephone 100 may project from the housing of system 10. As such, it is within the scope of the present disclosure that system 10 may be embodied or implemented in one or more components that are adapted to be coupled to telephone 100, without necessarily requiring the telephone to be internally received, or completely received, within the housing. While these latter, internalized configurations are also within the scope of the present disclosure, they are not required to all embodiments. It is also within the scope of the present disclosure that system 10 may include an integrated (i.e., non-removable) telephone 100, or component thereof.

Housing 30 may be configured to provide an at least partially, if not completely, sound-isolated environment within housing 30 such that the transmission of sound from the inside 92 to the outside 94 of housing 30, as well as the reverse, is reduced or attenuated. The at least partially sound-isolated environment within housing 30 may at least partially correspond to a volume that is on the inside 92 of, and at least partially enclosed by, housing 30. As such, sounds generated within housing 30 may have reduced volume outside of housing 30, and sounds generated outside housing 30 may have reduced volume within housing 30. While not required to all embodiments, this reduction may be a reduction of at least 30%, at least 50%, at least 75%, at least 90%, or even at least 99% of the original volume. For example, the reductions in volume may correspond to reductions in sound pressure level of 3 dB, 6 dB, 10 dB, or even 20 dB.

More particularly, housing 30 may be configured such that at least some sounds related to a telephone conversation between caller 200 and call receiver 300, which may include sounds emanating into the interior of housing 30, may be attenuated outside of housing 30. Such sounds may include audio signals or sounds 154 that are generated by a telephone 100 that is received within housing 30 as well as audio signals or sounds 152 that are produced by caller 200 while using system 10, such as speech sounds produced during a telephone call 160 with call receiver 300. For example, audio signals or sounds 154, which may include the reproduction of the call receiver's voice produced by an earpiece or speaker of telephone 100, and various other sounds emanating from telephone 100, which may include sounds indicating receipt of an incoming call such as ringing or “ring tones,” may be attenuated outside housing 30. Additionally, sounds 152 produced by caller 200 while using system 10 may be attenuated outside housing 30. Such attenuation of sound by housing 30 may at least partially or completely prevent persons, such as call neighbor 400, from hearing at least part, if not all, of telephone conversation 160 between caller 200 and call receiver 300, which may have the effect of enhancing privacy for caller 200 and call receiver 300. Additionally, attenuation of sounds emanating from within housing 30 may have the effect of enhancing the privacy and solitude of call neighbor 400 because call neighbor 400 may be at least partially screened from involuntarily hearing telephone conversations carried on by caller 200. Such enhancement of privacy for caller 200, call receiver 300, and call neighbor 400 may effectively make system 10 a “Conversation Privatizer.”

Additionally, housing 30 may be configured such that at least some sounds generated outside of housing 30, such as background sounds or noise, may be attenuated within housing 30. For example, sounds emanating from the environment surrounding caller 200, such as voices of various call neighbors 400, may be attenuated within housing 30. Such attenuation of external sounds within housing 30 may have the effect of improving the quality of telephone calls 160 for both caller 200 and call receiver 300. Reduced noise levels within housing 30 may make sounds 154 emanating from telephone 100 easier for caller 200 to hear. Additionally, call receiver 300 may be more able to hear the voice (or other sounds) 152 of caller 200 because caller 200 will be able to speak into telephone 100 within the reduced noise environment that may exist within housing 30. It is within the scope of the present disclosure that the attenuation of sounds from external housing 30 may, but are not required to, be within the illustrative ranges and/or thresholds described previously with respect to the attenuation of sound from internal housing 30.

In FIG. 2, a schematic diagram of an illustrative example of a telephone conversation isolation and enhancement system according to the present disclosure is shown generally at 10. Unless otherwise specified, system 10 may, but is not required to, contain at least one of the structure, components, functionality, and/or variations as the other telephone conversation isolation and enhancement systems described and/or illustrated herein. System 10 includes housing 30 and may include at least one seal 32 that is configured to provide an interface between housing 30 and caller 200. As indicated in FIG. 2, housing 30 may be configured such that seal 32 may engage caller 200. Ideally, housing 30 should be configured such that seal 32 and housing 30 are generally proximate the caller's mouth 204 and, in some embodiments, at least one ear 206, when caller 200 is using system 10.

An exemplary illustration of a suitable structural cross-section for housing 30 and seal 32 is shown in FIG. 3. Housing 30 may include a shell 60, which may be fabricated using any suitable process, such as die-casting, injection molding, pressing, stamping, or the like. Further, shell 60 may be fabricated from any suitable material, such as a lightweight plastic or metal, or the like. Although, shell 60 should be sufficiently rigid to generally maintain its shape during normal use of system 10, shell 60 may also be configured with sufficient flexibility to permit folding and/or rolling of housing 30, such as for storage when system 10 is not in use.

As shown in FIG. 3, seal 32 may be applied to, and/or extend from, housing 30 proximate an edge, or perimeter region, 88 of shell 60. Seal 32 may be secured to housing 30 in any suitable manner including adhesives, heat bonding, a suitable mechanical fastening system such as a hook-and-loop fastener or an interference or friction fit, or the like. Seal 32 may alternatively be formed with the housing and therefore may form an extension of the housing. Ideally, seal 32 should be configured to generally conform to the portion of the caller's face to which the seal is engaged, and seal 32 may be fabricated from any suitable material for doing so. In particular, seal 32 may provide an interface 90 between housing 30 and caller 200 in the proximity of the caller's mouth and/or ear. Seal 32 should be sufficiently flexible to provide a comfortable engagement with caller 200 while providing an interface 90 with caller 200 that attenuates the transmission of sound between the inside 92 and outside 94 of housing 30. Seal 32 may be formed from a resilient material.

Housing 30 may further include a sound-absorbing liner 34, which may be generally disposed over the interior surface of shell 60, as illustrated in FIG. 3. Liner 34 may be fabricated from any suitable sound-absorbing material, such as a lightweight flexible plastic foam or the like. Although liner 34 is shown in FIG. 3 as having a uniform thickness, liner 34 may have a non-uniform thickness and may occupy significant portions of the volume defined by shell 60. The appropriate thickness profile for liner 34 may be determined based on the acoustical and other design constraints of housing 30 and system 10. For example, the need for greater sound insulation in some portions of housing 30 may compel additional thickness of liner 34 in these portions, while physical constraints such as the need to provide space for telephone 100 or other components may dictate reduced thickness of liner 34 in certain locations. Although not necessary to the proper functioning of system 10, liner 34 may be secured to the inner surface of shell 60, via any suitable mechanism, such as with adhesive, hook-and-loop type fasteners, or the like. Additionally, or alternatively, liner 34 may generally be retained within shell 60 at least partially by an inner liner 36.

As shown in FIG. 3, housing 30 may be provided with inner liner 36. Inner liner 36 may provide an inner surface for housing 30. In some embodiments, inner liner 36 may be secured generally proximate edge 88 of shell 60, such that inner liner 36 may provide an uninterrupted cover over a substantial part of the interior of housing 30. As such, inner liner 36 may provide a durable and waterproof inner surface for housing 30. Such an inner liner may allow ready cleaning or disinfecting of system 10, such as between uses by different callers 200. Further, inner liner 36 may provide protection to various components that might be present within housing 30. Illustrative, non-exclusive examples of suitable materials for inner liner 36 may include vinyl, coated nylon, and the like. Optionally, the inner liner 36 may be made of, or include, a breathable membrane, such as sold under the brand name GORE-TEX™. A breathable inner liner 36 may effectively prevent moisture build-up within system 10, such as due to moisture caused by exhalation or perspiration from caller 200. In embodiments where inner liner 36 is secured relative to housing 30, inner liner 36 may optionally be secured to liner 34 and/or to shell 60 using any suitable method or mechanism.

Housing 30 may additionally or alternatively include at least one vent 38 that is adapted to permit moisture from within the housing to exit the housing. Vents 38 may establish an outlet through housing shell 60 and may be in fluid communication with inner liner 36 and/or with an inlet that extends through liner 36. In some embodiments that have vents 38, at least one of the vents 38 may be at least partially covered with a breathable membrane, such as inner liner 36.

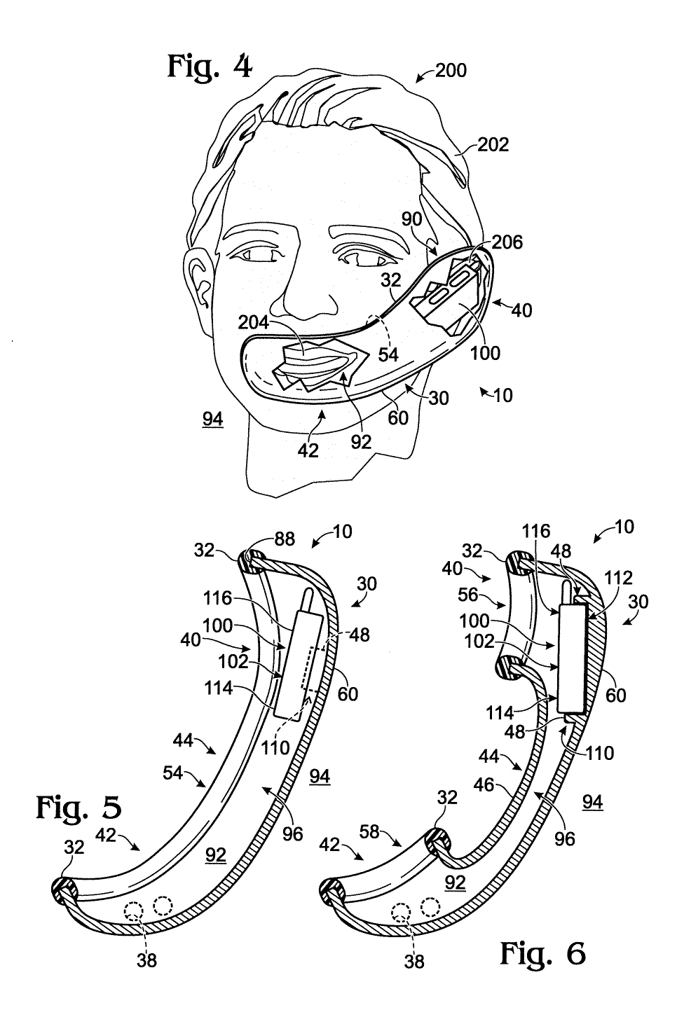

In FIGS. 4 and 5, an exemplary embodiment of a telephone conversation isolation and enhancement system according to the present disclosure is shown and generally indicated at 10. Unless otherwise specified, system 10 may, but is not required to, contain at least one of the structure, components, functionality, and/or variations as the other telephone conversation isolation and enhancement systems described and/or illustrated herein. As may be seen in FIGS. 4 and 5, housing 30 may include an opening 54 such that housing 30 may be configured into a generally elongated bowl shape. Opening 54 may be bounded by seal 32, which may be attached proximate edge 88 of shell 60, as discussed above and indicated in FIG. 5. Further, housing 30 may be configured with a suitably curved shape to allow ready disposition of housing 30 on a caller's head 202, as shown in FIG. 4. Suitable shaping of housing 30 may provide opening 54 with a suitable configuration such that seal 32 may be placed into generally continuous contact with head 202 of caller 200, such that interface 90 extends around the caller's mouth 204 and at least one of the caller's ears 206. Such a suitable curve for housing 30 may be readily seen in FIG. 5. Ideally, housing 30 and/or seal 32 should provide sufficient resilience, flexibility and deflection such that interface 90 is generally substantially circumferentially continuous around the perimeter of opening 54 despite variations in the shape of head 202, including variations that might occur when caller 200 is speaking. Thus, when system 10 is disposed on head 202, as shown in FIG. 4, the interface 90 created between seal 32 and head 202 may generally be uninterrupted around the circumference of opening 54, which may provide an effective seal to head 202 such that the transmission of sound between the inside 92 and outside 94 of housing 30 may be attenuated. Thus, system 10 may effectively attenuate the transmission of sounds, such as those emanating from mouth 204 and telephone 100, to the outside 94 of housing 30.

Housing 30 may include an upper section 40, a central section 44, and a lower section 42. Generally, upper section 40, central section 44, and lower section 42 together at least partly define a single contiguous volume such as that enclosed by the elongated bowl shape of housing 30. Such a contiguous volume comprises the inside 92 of housing 30, as shown in FIG. 5.

When housing 30 is disposed on head 202, upper section 40 should be configured to be disposed generally proximate ear 206. Upper section 40 may cover the caller's ear and may be configured to form a seal or interface around the caller's ear, such as to restrict noise from the outside 94 of housing 30 from passing to the user's ear.

Housing 30 may be adapted to removably receive a telephone, such as indicated at 100 in FIGS. 4 and 5. As such, housing 30 may include a mount 110 that is adapted to releasably couple telephone 100 in an operative position relative to housing 30 such that the telephone's microphone, or mouthpiece, 114 and speaker, or earpiece, 116 are each in an operative position. The telephone's mouthpiece is in an operative position when sounds produced by the caller may be transmitted to the mouthpiece, such as through a communication path, such that such sounds may ultimately be received by call receiver 300. The telephone's earpiece is in an operative position when audio signals or sounds produced by the telephone, such as corresponding to sounds from call receiver 300, may be transmitted from the earpiece, such as through a communication path, to the caller's ear 206. For example, as suggested in FIG. 5, upper section 40 may include a mount 110 that includes at least one phone-accepting member 48, which is adapted to retain telephone 100 relative to housing 30. In some embodiments, the at least one phone-accepting member 48 may include a plurality of spaced-apart phone-accepting members 48. The phone-accepting member or members 48 may be configured to receive a particular size and/or shape of telephone housing 102 or they may be adapted to universally accept a variety of sizes and/or shapes of telephone housing 102. For example, the phone-accepting member or members 48 may be adjustable such as by sliding, including repositionable and/or adjustable components, and the like. In some embodiments, the mount may include at least one suction cup or other retainer that is adapted to be secured to a telephone to position the telephone within housing 30. Mount 110 may additionally or alternatively be adapted to couple to a universal mounting device that may be attached to, or integrated into, telephone housing 102. In some embodiments, upper section 40 may be configured such that caller 200 may optionally use an earpiece, such as may be included or otherwise used with a cellular telephone, within housing 30.

In some embodiments, housing 30 may be configured with sufficient flexibility such that caller 200 may compress at least a portion of housing 30, such as by squeezing housing 30 with one of the user's hands, such that at least one inner surface, and optionally a pair of generally opposed surfaces, of housing 30 may engage telephone 100 to retain the telephone in a selected position relative to the housing. In such an embodiment, telephone 100 may thus be frictionally retained in an operative position, as discussed above. Depending on the relative sizes of housing 30 and the telephone housing 102 of a particular telephone 100, housing 30 may include at least one phone-accepting member 48 that is configured to bear against telephone housing 102, such as when caller 200 compresses housing 30, such that telephone 100 may be retained in an operative position.

In the illustrated example shown in FIGS. 4 and 5, telephone 100 is supported in upper region 40 of the housing, but such positioning is not required in all embodiments. It is within the scope of the present disclosure that housing 30 may be adapted to receive telephone 100 such that the telephone extends within at least one of sections 40, 42, and 44 of the housing. Upper section 40 and/or other portions of housing 30 may be sized such that any desired telephone 100 may be accommodated, regardless of the size and shape of the telephone's housing 102. However, in some embodiments, upper section 40 may be configured for particular types of telephone housing, such as various cellular telephones, corded phones, or the like. In other words, housing 30 may be sized to receive a particular type and/or size of telephone, or may be generally configured to receive a variety of sizes and/or types of telephones.

When housing 30 is disposed on head 202, lower section 42 should be configured to be disposed generally proximate mouth 204 such that lower section 42 may effectively cover, and preferably form an at least partial or even a complete seal around, mouth 204, as shown in FIG. 4. When caller 200 is using system 10, such as while making a telephone call to call receiver 300, caller 200 will be speaking into lower section 42. Ideally, housing 30 should provide a continuous communication path, such as sound channel 96, that extends from lower section 42, such as through central section 44, to telephone 100, which may be generally housed within upper section 40. Sound channel 96, which may generally be defined by a portion of head 202, seal 32, upper section 40, central section 44, and lower section 42 of housing 30, should be configured to allow ready transmission of the caller's voice from mouth 204 to the microphone 114 of telephone 100. When system 10 is used with a standard telephone handset, lower section 42 may be configured such that the mouthpiece may be disposed within housing 30 proximate to mouth 204.

As shown in FIG. 5, lower section 42 may be provided with at least one vent 38, which may prevent moisture build-up within system 10 such as due to moisture caused by exhalation or perspiration from caller 200. The vent or vents 38 may be of any suitable size, shape, and number to provide sufficient ventilation for housing 30. Further, the vent or vents 38 may be mutually configured with a sound-absorbing liner 34 and an inner liner 36 (as previously illustrated in FIG. 3) to provide sufficient ventilation while retaining the sound attenuating qualities of system 10.

In FIG. 6, another exemplary embodiment of a telephone conversation isolation and enhancement system according to the present disclosure is shown and generally indicated at 10. Unless otherwise specified, system 10 may, but is not required to, contain at least one of the structure, components, functionality, and/or variations as the other telephone conversation isolation and enhancement systems described and/or illustrated herein. As may be seen in FIG. 6, housing 30 may include an ear opening 56 and a mouth opening 58. Each of ear opening 56 and mouth opening 58 may be generally bounded by seal 32, which may be attached as discussed above. System 10 may be configured such that when system 10 is disposed on head 202, ear opening 56 may be disposed proximate ear 206 and mouth opening 58 may be disposed proximate mouth 204. Further, as described above, when system 10 is disposed on head 202, the seals 32 disposed on ear opening 56 and mouth opening 58 may provide concurrent seals to head 202 such that transmission of sound between the inside 92 and outside 94 of housing 30 may be attenuated.

As shown in FIG. 6, housing 30 may be configured such that central section 44 comprises a closed tubular cross-section. Such a closed tubular cross-section may take on any suitable closed shape such as generally circular, elliptical, polygonal, semi-circular, or the like. The cross-section may be suitably varied along its length as needed to provide optimal audio and/or mechanical functionality. When central section 44 comprises a closed tubular cross-section, central section 44 may effectively provide a handle 46, which may be adapted to be readily grasped by caller 200 when using system 10. Further, when central section 44 comprises a closed tubular cross-section, central section 44 may comprise sound channel 96, which may be configured to allow ready transmission of caller 200's voice from mouth 204 through lower section 42 and handle 46 to telephone 100 in upper section 40.

As shown in the illustrative embodiment presented in FIG. 6, housing 30 is adapted to removably receive a telephone, such as indicated at 100. In particular, housing 30 may include a mount 110 that includes spaced-apart phone-accepting members 48, which are adapted to retain telephone 100 relative to housing 30. As such, housing 30 may be described as defining a socket, or recess, 112 that is sized to receive telephone 100 in an operative position to transmit and receive sounds to and from caller 200 and call receiver 300, as discussed. Although the illustrative example presented in FIG. 6 shows the phone-accepting members 48 at upper and lower regions of telephone 100, it is within the scope of the present disclosure that the phone-accepting members 48 be configured to engage opposing sides of telephone 100, such as the left and rights sides of telephone 100. Further, although FIG. 6 shows telephone 100 supported in upper section 40 of housing 30, this positioning is not required to all embodiments. As discussed, housing 30 may be adapted to receive telephone 100 such that the telephone extends within at least one of sections 40, 42, and 44 of the housing.

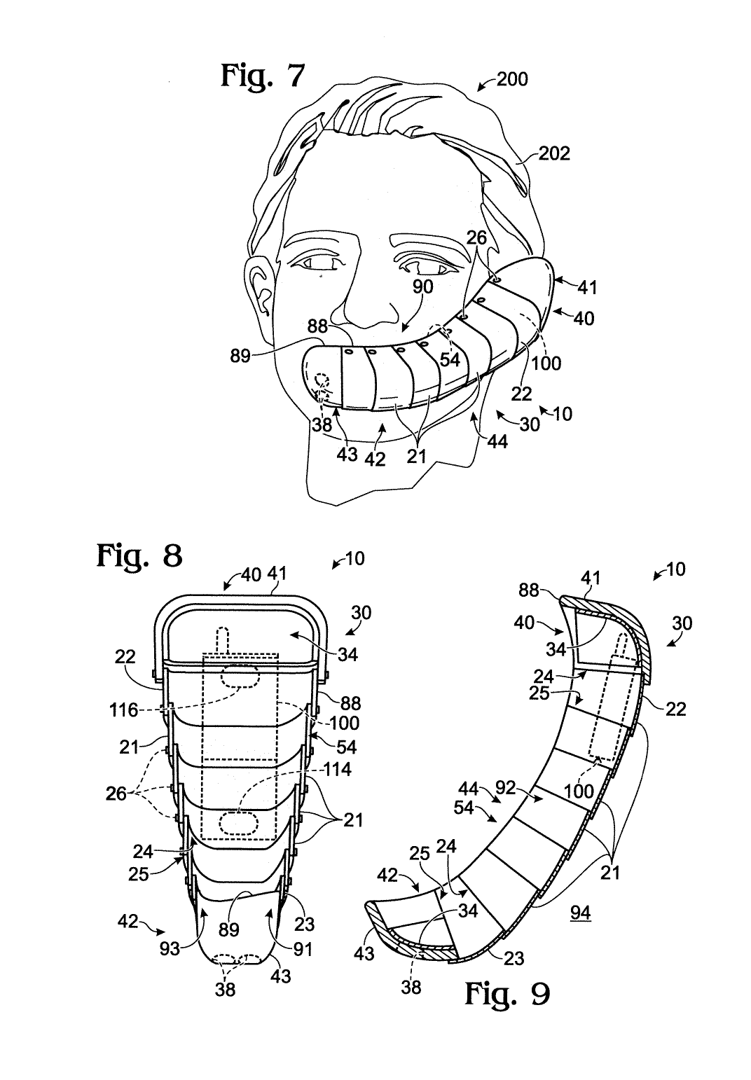

In FIGS. 7-9, another exemplary embodiment of a telephone conversation isolation and enhancement system according to the present disclosure is shown and generally indicated at 10. Unless otherwise specified, system 10 may, but is not required to, contain at least one of the structure, components, functionality, and/or variations as the other telephone conversation isolation and enhancement systems described and/or illustrated herein. As may be seen in FIGS. 7-9, housing 30 may include a plurality of flexibly connected pieces, such as first end piece 41, second end piece 43, and at least one intermediate segment 21. The upper section 40 of housing 30 may at least partially include first end piece 41, and the lower section 42 of housing 30 may at least partially include second end piece 43, which in some embodiments may include one or more vents 38. At least one of the first end piece 41 and the second end piece 43 may include a sound-absorbing liner 34 disposed therein, as shown in FIGS. 8-9, although this is not required to all embodiments.

As shown in FIG. 7, the second end piece 43 may include an edge 89 that may be configured to at least partially form edge 88 of housing 30 as well as the interface 90 around the caller's mouth. As such, edge 89 may be appropriately configured, such as by including one or more curved portions, to follow the geometries of a caller's head and face, such as surrounding the caller's mouth. Further, as shown in the exemplary embodiment presented in FIG. 8, edge 89 of second end piece 43 may be angled such that the depth of second end piece 43 may vary from side-to-side (or top-to-bottom when housing 30 is in use by caller 200, as shown in FIG. 7). For example, as shown in FIG. 8, the depth of second end piece 43 may be greater proximate first side 91 than proximate second side 93. The angled edge 89 of second end piece 43 may permit housing 30 to be angled relative to head 202 when housing 30 is disposed on head 202. For example, as generally shown in FIG. 7, when disposed on head 202, housing 30 may be angled generally upwardly from lower section 42 to upper section 40. The relatively greater depth of second end piece 43 proximate first side 91, as shown in FIG. 8, may configure housing 30 for use over the left ear of caller 200, as shown in FIG. 7, such as by enabling housing 30 to more readily angle upwardly from lower section 42 to upper section 40, such as while maintaining a substantially circumferentially continuous interface 90.

Although the exemplary embodiment of housing 30 presented in FIGS. 7 and 8 is configured for use with the left ear of caller 200, it is within the scope of this disclosure that housing 30 may be configured for use with the right ear of caller 200, in which case the depth of second end piece 43 may be greater proximate second side 93 than proximate first side 91, and/or for interchangeable use with either the right or left ears of caller 200. In many of the Figures, including FIGS. 8 and 9, telephone 100 has been somewhat schematically depicted. In FIG. 8, telephone 100 is shown in dashed lines to be a folding, or clamshell, style telephone to graphically represent that system 10 may be configured for use with a variety of styles and sizes of telephones.

As shown in FIGS. 7-9, the central section 44 of housing 30 may at least partially comprise a plurality of flexibly connected intermediate segments 21. In the exemplary embodiment presented in FIGS. 7-9, housing 30 includes seven flexibly connected intermediate segments 21. However, it is within the scope of the present disclosure for housing 30 to include any suitable number of flexibly connected intermediate segments 21, such as more or less than seven such segments, such as, for example, 1, 2, 3, 4, 5, 6, 7, 8, 9, or even 10, 15, 20, or more such segments. For example, the length of the central section 44 may be altered through utilization of more or fewer flexibly connected intermediate segments 21.

As shown in the exemplary embodiment presented in FIGS. 7-9, and as graphically depicted in FIGS. 8 and 9, each of the plurality of flexibly connected intermediate segments 21 may be configured into a generally U-shaped section that has a first end region 24 and a second end region 25 that is opposite first end region 24. Although each of the plurality of flexibly connected intermediate segments 21 in the exemplary embodiment presented in FIGS. 7-9 has a generally U-shaped configuration, it is within the scope of the present disclosure for at least one of the plurality of flexibly connected intermediate segments 21 to have an at least partially closed or tubular cross-section, such as suggested by the exemplary embodiment shown in FIG. 6. At least one of the flexibly connected intermediate segments 21 may be configured such that it retains its shape independently of the other segments. At least one of the flexibly connected intermediate segments 21 may be configured to have sufficient flexibility such that caller 200 may compress at least one of the at least one segments such that telephone 100 may be retained relative to housing 30. Although the plurality of flexibly connected intermediate segments 21 shown in the exemplary embodiment presented in FIG. 8 overlap and are of overlapping size, it is within the scope of this disclosure for the plurality of flexibly connected intermediate segments 21 to be of uniform size, to overlap to a greater or lesser extent, and/or to not overlap.

The plurality of flexibly connected intermediate segments 21 may be flexibly connected using any suitable flexible connection. Suitable flexible connections may include hinges or other pivot points, joints that combine flexure and sliding, and/or corrugations, folds, resilient hinges, pins, or other suitable features on housing 30 that may generally permit housing 30 to bend or flex. As shown in the exemplary embodiment presented in FIGS. 7 and 8, the plurality of flexibly connected intermediate segments 21 may be pivotingly connected such as with a plurality of pivot pins 26. Although the flexibly connected segments are shown in FIGS. 7-8 with pivot pins 26 disposed generally proximate the edge 88 of opening 54, it is within the scope of the present disclosure for a pivoting connection between any two of the flexibly connected segments to be disposed at any point or points along or near the junction between the two flexibly connected segments, such as proximate the midline of such segments or the like. The flexible connections may be configured to be freely flexible or to have some form of resistance to flexion, such as friction, detents, or the like, which may permit housing 30 to be at least partially retained in a selected configuration, such as a configuration sized to fit a particular caller's head and/or a collapsed or stored configuration.

As shown in at least FIG. 9, a first end region 24 of a first one 22 of the plurality of intermediate segments 21 may be flexibly connected to the first end piece 41 and the second end region 25 of the first one 22 of the plurality of intermediate segments 21 may be flexibly connected to the first end region 24 of an adjacent one of the plurality of intermediate segments 21. The first end region 24 of a second one 23 of the plurality of intermediate segments 21 may be flexibly connected to the second end region 25 of an adjacent one of the plurality of intermediate segments 21 and the second end region 25 of the second one 23 of the plurality of intermediate segments 21 may be flexibly connected to the second end piece 43. The first end region 24 of each of the remaining ones of the plurality of intermediate segments 21 may be flexibly connected to the second end region 25 of an adjacent one of the plurality of intermediate segments 21 and the second end region 25 of each of the remaining ones of the plurality of intermediate segments 21 may be flexibly connected to the first end region 24 of an adjacent one of the plurality of intermediate segments 21.

The housing 30 may be configured for compact storage, such as by folding or rolling the first end piece 41, the plurality of intermediate segments 21, and the second end piece 43 into a more compact arrangement. As shown in the exemplary embodiment presented in FIG. 8, the first end piece 41 may be wider than the first one 22 of the plurality of intermediate segments 21, which may be wider than succeeding ones of the plurality of intermediate segments 21, which may be wider than the second one 23 of the plurality of intermediate segments 21, which may be wider than the second end piece 43. In some embodiments, such as shown in FIG. 8, the second end piece 43 may be configured, to fit within the first end piece 41, such as when the housing 30 is rolled up for more compact storage.

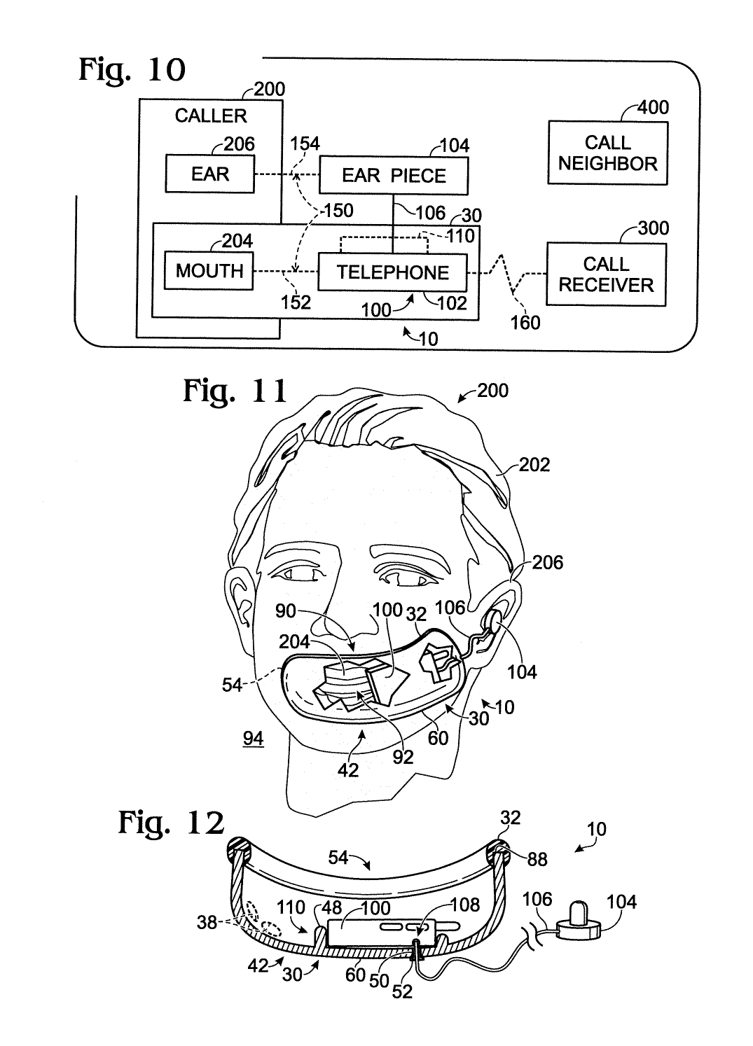

In FIG. 10, a schematic diagram of another illustrative example of a telephone conversation isolation and enhancement system according to the present disclosure is shown generally at 10. Unless otherwise specified, system 10 may, but is not required to, contain at least one of the structure, components, functionality, and/or variations as the other telephone conversation isolation and enhancement systems described and/or illustrated herein. As indicated in FIG. 10, system 10 may be configured for use with telephone 100 that has an earpiece 104 that is separately positionable relative to the telephone's housing 102. Earpiece 104 may be a standard or wired earpiece, such as may be plugged into a cellular or other type of telephone to allow hands-free use of the telephone, or earpiece 104 may be a wireless earpiece, such as one configured to operate as part of a wireless personal area network that is in compliance with the IEEE 802.15.1 standard, which is a short range wireless specification that is commonly referred to as BLUETOOTH®. BLUETOOTH® is a registered certification mark of the Bluetooth SIG. When earpiece 104 is a wired earpiece, earpiece 104 may generally be configured to connect to telephone 100 via an earpiece cord 106. Earpiece cord 106, or any other transmissive connection between telephone 100 and earpiece 104, may at least partially provide a communication path 150 between telephone 100 and ear 206. When configured for use with an earpiece 104, housing 30 may be configured to be disposed generally proximate mouth 204 while containing a telephone 100. In some embodiments, caller 200 may further utilize a second earpiece 104, such as when there are high noise levels proximate caller 200. It is within the scope of the present disclosure that earpiece 104 may be used with any of the embodiments of system 10 described and/or illustrated herein.

In FIGS. 11 and 12, another exemplary embodiment of a telephone conversation isolation and enhancement system according to the present disclosure is shown and generally indicated at 10. Unless otherwise specified, system 10 may, but is not required to, contain at least one of the structure, components, functionality, and/or variations as the other telephone conversation isolation and enhancement systems described and/or illustrated herein. As may be seen in the exemplary embodiment presented in FIG. 11, system 10 may include only lower section 42, such that upper section 40 and central section 44 may be omitted so as to provide a more compact unit due to the reduced size of housing 30. In such an embodiment of system 10, housing 30 may be generally adapted to be disposed on head 202 proximate mouth 204 such that seal 32 disposed on opening 54 may effectively attenuate transmission of sounds from mouth 204 and telephone 100 to the outside 94 of housing 30. System 10 may receive telephone 100 within housing 30 such as with phone-accepting members 48 or another suitable mount 110, which may be disposed within lower section 42, as shown in FIG. 12, such that telephone 100 may be proximate mouth 204. Housing 30 may be configured to be pressed against the caller's mouth by the caller and/or retained against the caller's mouth by a strap, band, or other support.

As shown in FIG. 11, audio signals from telephone 100 may be transmitted to ear 206 via a communication path, such as one that at least partially includes earpiece cord 106 and earpiece 104. Earpiece cord 106 may be plugged into telephone 100 such as at earpiece jack 108, as shown in FIG. 12. To allow continued effective sealing to head 202, housing 30 may include a passage for earpiece cord 106 such as earpiece cord outlet 50, which may include a grommet 52 adapted protect earpiece cord 106 such as from abrasion when cord 106 passes through shell 60. Grommet 52 may be configured to maintain the sound attenuating properties of housing 30. In some embodiments, rather than requiring that cord 106 be threaded through outlet 50, housing 30 may be provided with corresponding inner and outer jacks such that telephone 100 may be connected to an inner jack disposed on housing 30 while earpiece cord 106 may be connected to a jack disposed on the exterior of housing 30.

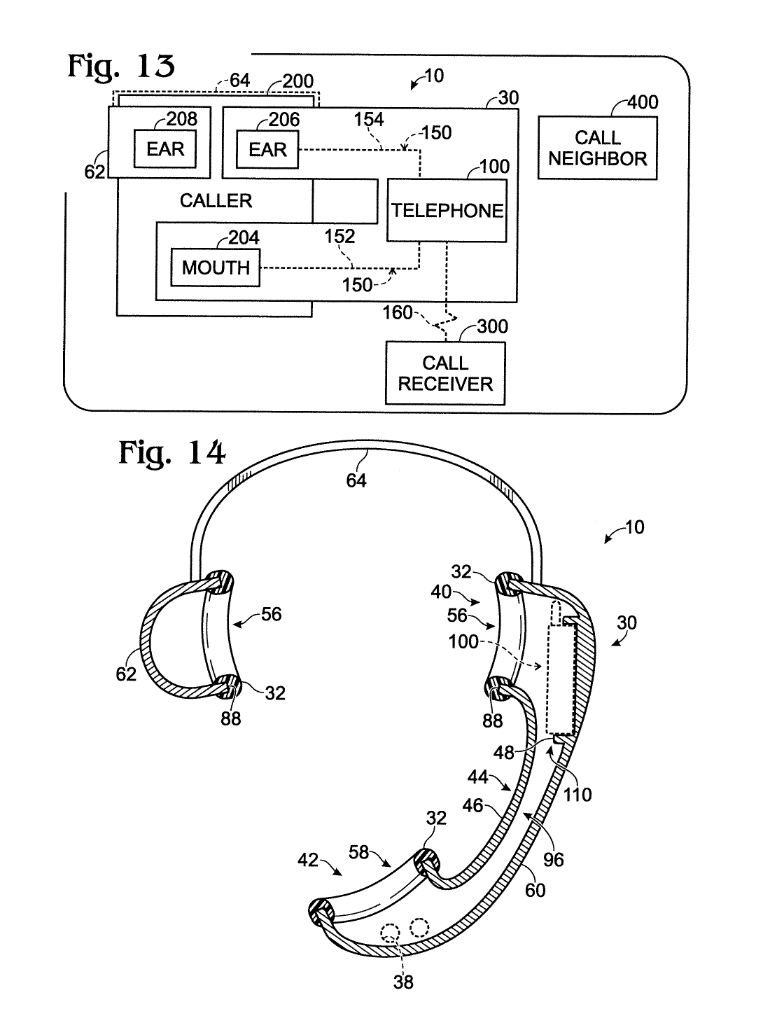

In FIG. 13, a schematic diagram of another illustrative example of a telephone conversation isolation and enhancement system according to the present disclosure is shown generally at 10. Unless otherwise specified, system 10 may, but is not required to, contain at least one of the structure, components, functionality, and/or variations as the other telephone conversation isolation and enhancement systems described and/or illustrated herein. As indicated in FIG. 13, system 10 may include a second housing or ear cup 62 that is configured to be disposed proximate the caller's second ear 208 when system 10 is disposed on head 202. Generally, ear cup 62 may contain the same structure, functionality, and variations as discussed above in regard to housing 30. Ear cup 62 may be attached to housing 30 such as with a headband 64, which may be adjustable for proper fit on head 202. Exemplary methods of adjustment for headband 64 may include a sliding mechanism, such as may be provided in a noise attenuating or stereophonic headset. Ear cup 62 also may be unitarily attached to housing 30, such as if ear cup 62 and shell 30 are fabricated as a single piece, in which case a connection between ear cup 62 and housing 30 may comprise a generally tubular configuration such that sounds 154 emanating from telephone 100 may be communicated to ear 208 through the tube. In some embodiments, ear cup 62 may include a speaker adapted to emit sounds 154 proximate ear 208.

In FIG. 14, another exemplary embodiment of a telephone conversation isolation and enhancement system according to the present disclosure is shown and generally indicated at 10. Unless otherwise specified, system 10 may, but is not required to, contain at least one of the structure, components, functionality, and/or variations as the other telephone conversation isolation and enhancement systems described and/or illustrated herein. As discussed above, and as shown in FIG. 14, an ear cup 62 may be attached to housing 30 through a headband 64, which may be adjustable for proper fit on head 202, such as in the manner of a noise attenuating or stereophonic headset. Ear cup 62 may be provided with a seal 32 disposed on edge 88 proximate the periphery of ear opening 56, as shown in FIG. 14, such as to provide effective sealing of ear cup 62 to head 202, as discussed above. When system 10 includes housing 30 and ear cup 62, caller 200 may be provided with the additional benefit of more complete attenuation of external sounds due to shielding of ears 206 and 208 from external sounds, such as may come from the environment or call neighbor 400, such as background noise. Such embodiments of system 10 may be particularly useful in relatively high noise environments, such as might be encountered aboard a commercial airliner, or the like.

System 10 may be configured for retention on head 202 using any suitable mechanism. For example, system 10 may include a portion that extends over the top of head 202, such as headband 64, in the manner of stereo headphones or noise attenuating headsets or the like, as generally shown in FIG. 14. System 10 may include a portion that extends around the rear of head 202. Inclusion of headband 64 may make system 10 suitable for hands-free use. It should be noted that such a headset-style arrangement may, but need not, include a second ear cup 62, as shown in FIG. 14. Optionally, housing 30 may be configured, as shown in the embodiment presented in FIG. 6, to provide a handle 46 adapted to be readily gripped by caller 200. Further, it is within the scope of this disclosure that seal 32 may be provided with an appropriate biocompatible adhesive such that system 10 may be retained on head 202 without the need for caller 200 to hold system 10 in place.

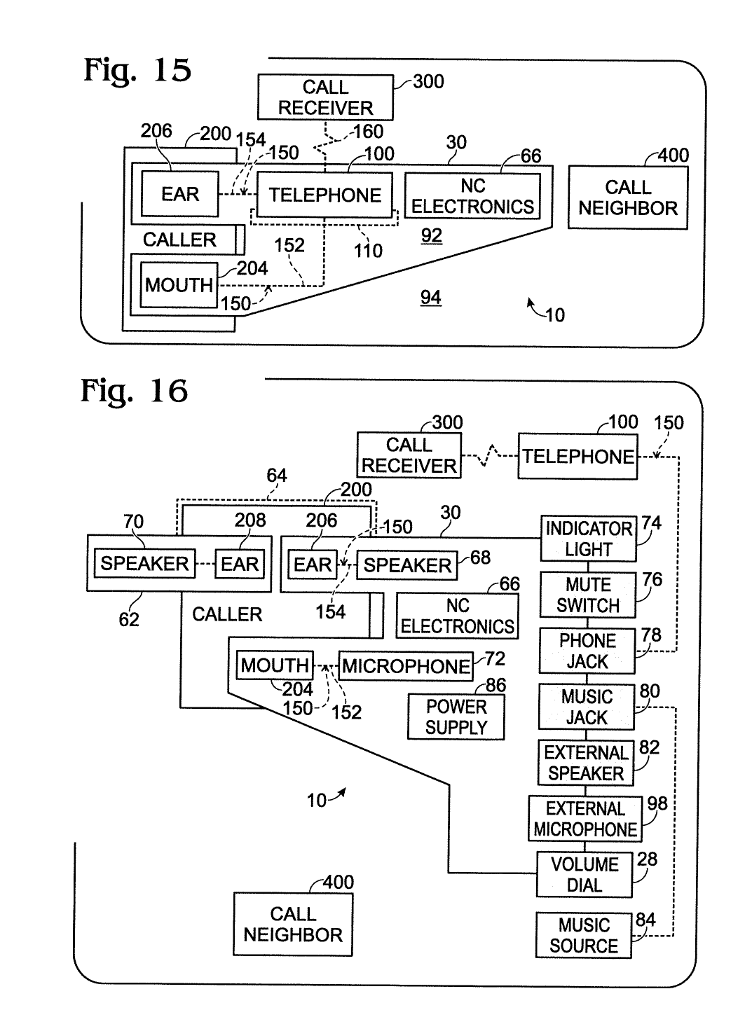

In FIG. 15, a schematic diagram of another illustrative example of a telephone conversation isolation and enhancement system according to the present disclosure is shown generally at 10. Unless otherwise specified, system 10 may, but is not required to, contain at least one of the structure, components, functionality, and/or variations as the other telephone conversation isolation and enhancement systems described and/or illustrated herein. As shown in FIG. 15, any embodiment of system 10 may include various noise canceling electronics 66, which may include components such as a microphone, a speaker, various circuitry, and a power source. Such noise cancellation electronics are available in commercial form from many suppliers, such as the BOSE Corporation or the David Clark Company Incorporated. In operation, exemplary versions of noise-canceling electronics 66 may generally emit a sound signal, such as one that is 180 degrees out of phase with certain other sounds, that may effectively cancel out those other sounds. The noise-canceling electronics 66 may also take an incoming signal from a telephone 100 as an input and use that signal as part of the noise-canceling dynamics. Noise-canceling electronics 66 may also be configured to more fully attenuate sounds originating within housing 30, such as voice 152 or sounds 154 emanating from telephone 100, such that the telephone conversation of caller 100 may be more effectively shielded from call neighbor 400. The noise-canceling electronics 66 could also be employed to amplify sounds 154 emanating from telephone 100 to improve the ability of caller 200 to hear sounds 154. Further, the noise-canceling electronics 66 may additionally attenuate sounds generated outside 94 of housing 30, such as background noise, such that caller 200 may more readily hear sounds 154.

In FIG. 16, a schematic diagram of another illustrative example of a telephone conversation isolation and enhancement system according to the present disclosure is shown generally at 10. Unless otherwise specified, system 10 may, but is not required to, contain at least one of the structure, components, functionality, and/or variations as the other telephone conversation isolation and enhancement systems described and/or illustrated herein. The example of system 10 shown in FIG. 16 is not intended to represent any specific embodiment, but rather it is intended to provide an illustrative, non-exclusive set of examples of many of the wide range of possible components that may be included in embodiments of system 10, individually or in various possible combinations. For example, any embodiment of system 10 may include noise-canceling electronics 66, as discussed above. Further, system 10 may include speaker 68 and/or speaker 70, wherein system 10 is configured such that, when system 10 is disposed on head 202 of caller 200, speakers 68 and 70 may be disposed proximate the caller's ears 206 and 208, respectively.

Some embodiments of system 10 may include a mute switch 76, which may be located on the exterior of housing 30. Mute switch 76 may be configured to mute, such as within housing 30, sounds 154 emanating from telephone 100, such that caller 200 may more readily hear and communicate with call neighbor 400. Further, system 10 may be configured such that mute switch 76 may enable an external microphone 98 to pick up sound from outside housing 30, such as may emanate from call neighbor 400, and transmit these sounds to caller 200 through speaker 68, which may enable more ready communication between caller 200 and call neighbor 400 while system 10 is disposed on head 202 of caller 200.

Communications between caller 200 and call neighbor 400 may be further enhanced by inclusion of an internal microphone 72, an external speaker 82 and appropriate circuitry such that voice 152 of caller 200 may be more readily heard by call neighbor 400 despite the noise attenuating effects of system 10 discussed above. For example, such as when caller 200 activates the mute switch 76 as discussed above, microphone 72 may pick up voice 152 and rebroadcast voice 152 through external speaker 82 in a manner appropriate to allow call neighbor 400 to readily hear voice 152. Because ambient noise conditions may vary radically, such as between a quiet location and aboard a commercial airliner, system 10 may be provided with a suitable volume control, such as an external volume dial 28, which may control the volume of sounds emanating from external speaker 82. Volume dial 28 may additionally or alternatively be configured to allow adjustment of the volume of sounds 154 emanating from speakers 68 and/or 70.

System 10 may further be provided with an indicator light 74 disposed on the exterior of housing 30. Indicator light 74 may be configured such that light 74 may provide an indication, such as to call neighbor 400, whether or not caller 200 can hear call neighbor 400 and/or whether or not caller 200 is using telephone 100. Such an indication may comprise either an appropriate color, such as green, red, or the like, or appropriately chosen words, such as “I'M LISTENING,” “ON A CALL NOW,” or the like.

Rather than being adapted to receive telephone 100 within housing 30, some embodiments of system 10 may be configured to at least partially establish at least one communication path 150 with an exterior telephone 100, such as through a phone jack 78 configured to receive an appropriate connection to telephone 100 or through a wireless connection, such as one that is in compliance with the BLUETOOTH® specification, as discussed above. In some embodiments, device 10 may therefore additionally or alternatively be configured to receive a wireless or other headset, such as may include an earpiece or other speaker for transmitting sound to the caller and a microphone for receiving sounds from the caller. In such embodiments, system 10 may be provided with an internal microphone 72 configured to receive audio signals or sounds 152, such as speech sounds from caller 200, for transmission at least partially through at least one communication path 150, such as through phone jack 78, to telephone 100. Additionally, phone jack 78 may be configured to transmit, at least partially through at least one communications path 150, such as through phone jack 78, audio signals or sounds 154 emanating from telephone 100 to speaker 68 and/or speaker 70 such that caller 200 may hear sounds 154.

Some embodiments of system 10, especially the more advanced examples such as those including noise-cancellation electronics 66 or the like, may include an appropriate power supply 86. Power supply 86 may be housed at least partially within system 10 such as when power supply 86 may be disposed on or within housing 30. When power supply 86 is housed within system 10, system 10 may be self-contained such that caller 200 may use system 10 without any constraints on location. In some embodiments, power supply 86 may be housed at least partially external to system 10, such that caller 200 may need to connect system 10 to a suitable external power supply.

The inclusion in system 10 of sound-attenuating features, such as those discussed above, which may include some form of noise cancellation electronics 66, may make system 10 particularly suitable for use as a stereophonic headset, such as may be used for high fidelity musical listening. As such, system 10 may be provided with a music source 84. Although music source 84 may be disposed within system 10, music source 84 may be at least partially external to system 10. Music source 84 may include any mechanism for producing a high quality musical signal such as a CD player, a DVD player, a personal computer, an FM radio receiver, a satellite radio music receiver, an MP3 player, or the like. To receive an audio input signal, such as from music source 84, system 10 may be provided with a music jack 80, which may be disposed on housing 30. When system 10 is configured to play music, such as described above, system 10 may be configured to detect when an incoming phone call is being received by telephone 100. When so configured to detect an incoming call, system 10 may further be configured such that an input signal from telephone 100 may override any input from music source 84, such as by muting the music in favor of caller 200 hearing sounds 154 emanating from telephone 100.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

I claim:

1. A telephone conversation isolation and enhancement system suitable for use by a caller who is using a telephone to participate in a telephone call, the system comprising:
an elongate housing comprising an edge that circumferentially bounds an opening, wherein the edge is configured to contact a caller's head to create a substantially circumferentially continuous interface between the edge and the caller's head when the housing is disposed with the opening proximate the caller's head, wherein the interface encloses a caller's mouth such that speech sounds produced by the caller will emanate into a volume enclosed by the housing and a portion of the caller's head that is bounded by the interface, wherein the housing is configured to attenuate transmission of the speech sounds to a call neighbor;
a first communication path configured to enable speech sounds produced by the caller to reach a telephone; and
a second communication path configured to enable transmission of audio signals from the telephone to at least one of the caller's ears, wherein the second communication path is configured to attenuate transmission of audio signals from the telephone to the call neighbor.

2. The telephone conversation isolation and enhancement system of claim 1, wherein the housing is configured to provide at least a 30% reduction in the transmission of the speech sounds to the call neighbor.

3. The telephone conversation isolation and enhancement system of claim 1, wherein the interface encloses at least one of the caller's ears.

4. The telephone conversation isolation and enhancement system of claim 3, wherein the housing is configured to attenuate transmission of at least some sounds generated outside of the housing to the at least one of the caller's ears.

5. The telephone conversation isolation and enhancement system of claim 3, comprising a second housing comprising a second edge that circumferentially bounds a second opening, wherein the second edge is configured to contact the caller's head to create a substantially circumferentially continuous second interface between the second edge and the caller's head when the second housing is disposed with the second opening proximate the caller's head, wherein the second interface encloses a second one of the caller's ears.

6. The telephone conversation isolation and enhancement system of claim 1, wherein the housing is configured to receive the telephone therein.

7. The telephone conversation isolation and enhancement system of claim 6, wherein the housing comprises at least one phone-accepting member configured to releasably hold the telephone with the volume of the housing.

8. The telephone conversation isolation and enhancement system of claim 6, wherein the housing comprises at least one portion having sufficient flexibility such that the caller may compress at least one of the at least one portions such that the telephone is retained relative to the housing.

9. The telephone conversation isolation and enhancement system of claim 6, wherein at least one of the first communication path and the second communication path comprises propagation of sound through the air within the volume enclosed by the housing.

10. The telephone conversation isolation and enhancement system of claim 1, wherein the housing comprises:
a first end piece;
a second end piece; and
a plurality of flexibly connected intermediate segments, wherein each of the plurality of flexibly connected intermediate segments comprises a first end region and a second end region opposite the first end region, wherein the first end region of a first one of the plurality of intermediate segments is flexibly connected to the first end piece and the second end region of the first one of the plurality of intermediate segments is flexibly connected to the first end region of an adjacent one of the plurality of intermediate segments, wherein the first end region of a second one of the plurality of intermediate segments is flexibly connected to the second end region of an adjacent one of the plurality of intermediate segments and the second end region of the second one of the plurality of intermediate segments is flexibly connected to the second end piece, wherein the first end region of each of the remaining ones of the plurality of intermediate segments is flexibly connected to the second end region of an adjacent one of the plurality of intermediate segments and the second end region of each of the remaining ones of the plurality of intermediate segments is flexibly connected to the first end region of an adjacent one of the plurality of intermediate segments.

11. The telephone conversation isolation and enhancement system of claim 10, wherein each of the flexible connections comprises a pivoting joint.

12. The telephone conversation isolation and enhancement system of claim 10, wherein at least one of the intermediate segments is configured to have sufficient flexibility such that the caller may compress at least one of the at least one intermediate segments such that the telephone is retained relative to the housing by the at least one intermediate segment.

13. The telephone conversation isolation and enhancement system of claim 1, wherein:
the first communication path includes a microphone disposed within the housing, wherein the microphone is connected to the telephone; and
the second communication path includes a speaker disposed within the housing, wherein the speaker is connected to the telephone.

14. The telephone conversation isolation and enhancement system of claim 13, wherein the telephone is disposed outside of the housing.

15. The telephone conversation isolation and enhancement system of claim 13, comprising a wired connection between the telephone and at least one of the microphone and the speaker.

16. The telephone conversation isolation and enhancement system of claim 13, comprising a wireless connection between the telephone and at least one of the microphone and the speaker.

17. The telephone conversation isolation and enhancement system of claim 1, wherein the housing comprises at least one vent opening.

18. The telephone conversation isolation and enhancement system of claim 17, wherein at least one of the at least one vent openings is covered by a liner comprising a breathable membrane.

19. The telephone conversation isolation and enhancement system of claim 1, wherein the housing comprises at least one interior region having a liner disposed therein, wherein the liner comprises a sound-absorbing material.

20. A method permitting a caller using a telephone to participate in a telephone call to isolate sounds associated with the telephone call from call neighbors, the method comprising:
providing an elongate housing comprising an edge that circumferentially bounds an opening on the housing;
disposing the housing proximate a caller's head such that:
the edge contacts the caller's head and creates a substantially circumferentially continuous interface between the edge and the caller's head, and
the interface encloses a caller's mouth such that speech sounds produced by the caller will emanate into a volume enclosed by the housing and a portion of the caller's head that is bounded by the interface, wherein the housing is configured to attenuate transmission of the speech sounds to a call neighbor;
speaking into the volume such that speech sounds produced by the caller are transmitted to a telephone; and
receiving audio signals produced by the telephone at at least one of the caller's ears.

21. The method of claim 20, wherein the housing comprises:
a first end piece;
a second end piece; and
a plurality of flexibly connected intermediate segments, wherein each of the plurality of flexibly connected intermediate segments comprises a first end region and a second end region opposite the first end region, wherein the first end region of a first one of the plurality of intermediate segments is flexibly connected to the first end piece and the second end region of the first one of the plurality of intermediate segments is flexibly connected to the first end region of an adjacent one of the plurality of intermediate segments, wherein the first end region of a second one of the plurality of intermediate segments is flexibly connected to the second end region of an adjacent one of the plurality of intermediate segments and the second end region of the second one of the plurality of intermediate segments is flexibly connected to the second end piece, wherein the first end region of each of the remaining ones of the plurality of intermediate segments is flexibly connected to the second end region of an adjacent one of the plurality of intermediate segments and the second end region of each of the remaining ones of the plurality of intermediate segments is flexibly connected to the first end region of an adjacent one of the plurality of intermediate segments.

22. The method of claim 21, wherein each of the flexible segments comprises a pivoting joint.

23. The method of claim 21, comprising disposing the telephone within the housing and compressing at least one of the intermediate segments such that the telephone is retained relative to the housing.

24. The method of claim 20, wherein the interface encloses at least one of the caller's ears.

25. The method of claim 20, comprising providing the housing with at least one vent opening that is covered with a liner comprising a breathable membrane.

26. The method of claim 20, comprising providing at least one interior region of the housing with a liner comprising a sound-absorbing material.

27. A telephone conversation isolation and enhancement system suitable for use by a caller who is using a telephone to participate in a telephone call, the system comprising:
an elongate housing comprising an edge that circumferentially bounds an opening, wherein the edge is configured to contact a caller's head to create a substantially circumferentially continuous interface between the edge and the caller's head when the housing is disposed with the opening proximate the caller's head, wherein the interface encloses a caller's mouth such that speech sounds produced by the caller will emanate into a volume enclosed by the housing and a portion of the caller's head that is bounded by the interface, wherein the housing is configured to attenuate transmission of the speech sounds to a call neighbor, wherein the housing comprises:
at least one vent opening, wherein at least one of the at least one vent openings is covered by a breathable membrane, and
at least one interior region having a liner disposed therein, wherein the liner comprises a sound-absorbing material;
a first communication path configured to enable speech sounds produced by the caller to reach a telephone disposed within the housing; and
a second communication path configured to enable transmission of audio signals from the telephone to at least one of the caller's ears, wherein the interface encloses at least one of the caller's ears, wherein the housing is configured to attenuate transmission of at least some sounds generated outside of the housing to the at least one of the caller's ears.
